(19) United States
(12) Patent Application Publication
(10) Pub. No.: US 2003/0023439 A1
(43) Pub. Date: Jan. 30, 2003

(54) Method and apparatus for automatic recognition of long sequences of spoken digits

(76) Inventors: Gregory Ciurpita, Somerset, NJ (US); Sunil K. Gupta, Edison, NJ (US); Prabhu Ragavan, Edison, NJ (US)

Correspondence Address: HARNESS, DICKEY & PIERCE, P.L.C., P.O. BOX 8910, RESTON, VA, 20195, US

(21) Appl. No.: 09/846,200

(22) Filed: May 2, 2001

(51) Int. Cl. G10L 15/00; G10L 17/00

(52) U.S. Cl. 704/246

(57) ABSTRACT

A method and system of recognizing speech based in part on an observation that a speaker naturally pauses and speaks smaller subgroups of speech units or digits that form part of a complete longer speech sequence. In the method, subgroups of speech units are processed by the system between a human's natural pauses. This pause is detected by the system and the subgroup is processed in order to provide a recognition result, which is a best representation of the input subgroup. The recognition result is immediately repeated back to the user for verification. The user is prompted to repeat a subgroup for re-recognition and re-verification if a rejection criteria is met; otherwise the processing steps are repeated for remaining subgroups until it has been determined that the complete speech sequence has been accurately recognized.

### BACKGROUND OF THE INVENTION

1. Technical Field of the Invention

This invention relates generally to field of speech recognition and, more particularly, a method and a system to improve overall recognition of speech by recognizing shorter speech segments.

2. Description of Related Art

Automatic speech recognition (ASR) or voice recognition (VR) systems have begun to gain widened acceptance in a variety of practical applications. In conventional voice recognition systems, a caller interacts with a voice response unit having a voice recognition capability. Such systems typically either request a verbal input or present the user with a menu of choices, and wait for a verbal response, interpret the response using voice recognition techniques, and carry out the requested action, all typically without human intervention.

Further, the conventional voice recognition systems recognize sequences of spoken letters and/or digits, such as a 10-digit telephone number, 16-digit credit card number, etc. These systems may acquire these sequences from several utterances from a user, as needed, in order to provide the appropriate number of digits. Thus one issue in designing a user interface for a system using voice recognition concerns handling the potential of recognition errors. This is because it has been recognized that whenever these conventional voice recognition systems interpret a digit sequence (such as a 16-digit credit card number) there is some uncertainty as to the correspondence between the utterance and the interpretation. Current systems tend to recognize a complete digit sequence (such as the aforementioned 16-digit credit card sequence) as a single utterance.

This is somewhat analogous to a DTMF (Dual Tone Multi-frequency) detector in a digit recognition system, which typically recognizes a digit sequence such as a credit card only after a user has keyed in a complete digit sequence and then keys the pound (#) key, which is a termination character, on the dial pad. Since the recognition accuracy accordingly decreases geometrically as a function of a number of digits to be recognized, this in turn often leads to a poor recognition of longer digit sequences.

In order to deal with these potential errors, conventional systems may use some type of verification for all transactions in situations where the error rate may cause concern, in order to avoid the possibility of processing an incorrect digit string. For example, following the input of each connected digit string, a voice recognition system may “read back” (i.e., feedback) the best digit string candidate, and require an affirmative or negative response from the individual using the system. An example would be: “please say yes if your credit card number is 1234-5678-9012-3456”, and please say “no otherwise”. Although this type of verification is often necessary and useful, it is more often cumbersome, time consuming and generally tortuous for frequent users of a voice recognition system.

However, it has been observed that when someone speaks out sequence of digits, whether short or long such as a telephone number or credit card number for example, to someone else, he/she tends to do so in natural groups of smaller digit strings or subgroups, such as several digits at a time, with a natural pause between subgroups. An exemplary situation may involve a caller talking to a customer service representative about making a credit card payment for a particular item. Usually, after each subgroup of the digit sequence is uttered, the listener (customer service representative) repeats the subgroup or subsequence, thus providing potentially useful feedback to the speaker.

Voice recognition systems process utterances that may be short or long. However, even single-digit voice recognition won't be as accurate as DTMF detection, because a voice recognition system cannot control how people speak. Accordingly, what is needed is a method and system that works naturally, the way people interact with each other today, to recognize sequences of speech units between these natural pauses of a human and provide useful feedback. In other words, the system takes advantage of these natural pauses between utterances to provide feedback to the user. Further, such a system would need a mechanism to allow a user of the system the ability to reject what is fed back, and to repeat it, perhaps using a series of smaller sequences.

### SUMMARY OF THE INVENTION

In order to overcome the above deficiencies in automatic speech recognition of sequences of spoken speech units, a method and system of recognizing speech in user-interface recognition systems has been developed, that is based at least partially on the above observation that a speaker naturally pauses and may speak in smaller subgroups of speech units or digits that form part of a complete longer speech sequence. The system attempts to provide feedback after each subgroup by repeating the recognition results, allowing the user to correct the results if erroneous. Additionally, the method and system take advantage of an observation that a human being not only naturally speaks slower when errors in recognition occur, but will also naturally speak in smaller groups of speech units as repeated errors in speech verification occur.

In the method, an utterance or subgroup of speech units are received or detected by the system between the aforementioned natural pauses. This pause is detected by the system and the subgroup is processed in order to provide an interpretation or recognition result that is temporarily stored in the system. The recognition result, which is a best representation of the input subgroup, is immediately repeated back to the user for verification. Each recognition result of a subgroup or sequence (i.e., best system interpretation of sequence) is verified by being fed back to the user. For example, if a rejection criteria is met, such as the user rejecting a recognition result by saying “no” for example, the sequence being verified is rejected, and the sequence prior to that (previous result) is fed back for re-verification. The system also provides for multiple occurrences of “no” being uttered by the user, and even mis-recognition of a user's negative utterance by the system itself, by enabling the user to skip back where necessary to correct errors. Otherwise, if there are no errors indicated in the results (such as when the user immediately inputs the next subgroup), the processing steps are repeated for remaining subgroups or sub digit-sequences until it has been determined that the complete speech sequence has been accurately recognized.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus are not limitative of the present invention, and wherein:

FIG. 1 is a state diagram that generally describes the method in accordance with the present invention;

FIG. 2 is an illustrative block diagram showing comparable functionality between a DTMF system and the voice recognition system of the invention;

FIG. 3 is a block diagram of the voice recognition system, including voice recognition engine, system controller (QFE processing section) and TTS generator; and

FIG. 4 illustrates the contents of an exemplary recognition grammar.

### DETAILED DESCRIPTION

The method and system of the present invention recognizes the fact that shorter digit sequences are more accurately recognized than longer digit sequences. Additionally, given the observation that when speaking a long sequence of digits, the user or speaker naturally breaks up the sequence into several subgroups of speech units with pauses in between, the method and system of the present invention provides useful feedback to a speaker or user of the system. This allows users to reject incorrect recognition results, with the system taking advantage of these shorter utterances or subgroups to improve system recognition performance.

As defined herein, the term “speech unit” is indicative of a single digit, letter or word that is defined in the grammar, and may be occasionally referred as such by any of the above hereafter. An “utterance” input by a user may be any speech that is represented by a digit-sequence and delimited by some minimum period of silence. Additionally where used, digit-sequence or digit-string may be one or more digits or words, and may also be referred to as a subgroup. The phrase “recognition result” is the best interpretation of a subgroup of speech units or digit-sequence that has been determined by the system of the present invention. Where used, the terms “speaker” or “user” are synonymous and represent a person who is using the system of the present invention. Further, the “pause” discussed in the present invention may be silence that is roughly the duration of one or more words. Additionally, the pause duration may equate to a period of silence that exists between words in a spoken sentence.

As further detailed hereinafter, in the system of the invention a user may speak a digit sequence that may be part of a larger complete long-digit sequence, such as multiple digit-sequences forming a complete sequence such as a credit-card number. The voice recognition (VR) system automatically detects a natural pause between subgroups and feeds back information to the user. Such can be accomplished using text-to-speech (TTS) synthesis techniques or by using pre-recorded prompts, as is discussed in further detail below.

For example, the speaker or user may continue further if the recognized subgroup is correct, or may reject the repeated subgroup by means of one or more negative utterances or verbal indications, such as by verbally indicating a mistake during the course of speaking a particular sequence that is understood by the system. Additionally, the speaker or user may reject received feedback from the system any time before the system completes repeating the recognition result, or may reject a current sequence while providing correction for a previous sequence, all within a single utterance. The present invention is not limited to the above arrangements, as is explained below. The process is repeated until all subgroups forming the complete longer sequence have been correctly recognized by the system.

The method and system are advantageous in that they are of a non-complex nature and do not require training on the part of the user or speaker, since it is quite natural for users to pause between recitation of short subgroups of speech units in their everyday experience. Additionally the method and system generally follow American societal protocols for interaction, (i.e., consistent with the way people act in American culture). Further, the proposed method and system allows the user to change the recognition performance, although he/she may not know it, by speaking in smaller digit-sequences.

Unlike a DTMF system where there are a limited number of inputs (i.e., the dial pad of a telephone for example, 0-9, * and #), a VR based system cannot control or limit the input speech, since the speech may be fast or slow, in any language, with a particular accent, or may include other speech impediments. As an example of this lack of control, when a native of Brooklyn, N.Y. says “THIRTY-THIRD”, a VR system might process “tirty-tird” (unintelligible by the system) instead of “THIRTY-THIRD”, due to the Brooklyn native's accent. Although many Americans would likely recognize this speech, in the conventional system it would be unrecognizable. The proposed method and system encourages the user to speak in ways that are recognizable by the system, so as to verify results from varied speech inputs, just as humans typically do.

The system of the present invention may be embodied as a single digital signal processor (DSP) capable of performing voice recognition and feedback, and may include a VR engine, system controller, and text-to-speech (TTS) generator. This allows the system to wait for user voice inputs, provided feedback to these inputs, and then to process a complete and accurate digit sequence based in part on the user's response to the feedback. The system is not limited to a DSP; the algorithms of the invention may be implemented on a general purpose processor, PC, mainframe, etc.

Since mistakes or errors as described above are almost bound to occur, with voice-recognition, feedback is necessary in order to help a speaker or user use the system. A voice-recognition interface is inherently different from the dial pad interface. For comparison, a DTMF interface provides results as soon as DTMF signals have been detected for a minimum length of time, perhaps as little as 50 ms. If a user is entering a long string of numbers, such as a credit card number for example, the system detects the dial pad button presses before the user has even lifted their finger off the button.

The voice-recognition system, however, does not produce any result until after the end of an utterance has been detected. This time period therefore includes the time to speak the utterance, or digits, plus some period of silence to recognize that the user has stopped speaking, after which a burst of recognition results is produced. This is in contradistinction to the DTMF detection scheme that produces results as generated. In the present VR system, a system controller or processor queues up multiple VR engine results (i.e., a digit sequence) across multiple human utterances, in order to construct a complete verified digit-sequence representing a credit card number.

An optimal voice recognition feedback is dependent on the situation, the probability of error, the user, and the mood of the user. Accuracy is generally not a problem in DTMF systems since DTMF detectors are sufficiently accurate and do not need to feedback results to a user. However, VR systems are not sufficiently accurate so as to provide reliable results in general applications. Therefore, a VR system using feedback is one approach to providing reliable results.

As briefly noted above, recognition results improve if the user speaks to a voice-recognition system as if it were human, providing pauses to process the subgroups of digits. The “breaking up” of long digit strings into subgroups allows the system, or human, the opportunity to provide feedback, so that any mistakes are corrected. Corrections can be made on each subgroup, rather than starting at the beginning of the long-sequence digit string. This capability is needed regardless of the size of a digit-sequence that is input by the user, since even single-digit recognition results are not sufficiently accurate.

In the present invention, confirmation can be implicit, i.e., if the user response to feedback of the previous sequence is simply an utterance with the next subgroup, the previous results are confirmed by the system. At the end of a complete sequence verification (i.e., the last subgroup has been fed back to the user), user silence an/or an explicit user response to a fed back prompt could indicate verification of the complete speech sequence. The method and system use a voice-recognition grammar that includes the dial pad keys (including ‘zero’ for the number “0”) and a negative indicator such as the word “no. For example, after hearing feedback from the system, the user would say “no” if there was a mistake, or continue with the next digits-subgroup if it were correct, as noted above

Accordingly, within the system feedback the following may occur:

(a) the user could listen through the entire feedback (repeated subgroup), and then continue with the next digits-subgroup (i.e., “123” is repeated; the user realizes this is correct and says the next subgroup “456”); or

(b) the user could hear a mistake in the feedback (incorrect repeated subgroup), so he/she can reject the result (i.e., user hears “457” instead of “456”, so he/she says “no” either before or after the feedback completes). In this case the previous subgroup is repeated (e.g., “123”) so the user can repeat input of “456”; or

(c) the user may reject the current results and immediately repeat the subgroup (e.g. “no 456”). In this case, the system will discard the subgroup being rejected, and repeat the recognition results for the speech following “no”, without repeating the previous results; or

(d) the user may also begin speaking the next subgroup without waiting for the repeated results to be completely played back, in which case, the current and previous results are concatenated together and treated as a single subgroup (e.g. “123456”); or

(e) the user may speak “no” repeatedly, rejecting previously accepted subgroups. This also foresees the scenario where a spoken “no” for a subgroup or series of subgroups was not recognized by the system, contributing to an erroneous result.

Regardless of the number of subgroups or utterances, all recognition results must be confirmed. After being fed back to the user, all recognition results are assumed to be confirmed unless explicitly rejected by the user; such as through a negative command like “no” for example. Moreover, results that have already been confirmed can still be rejected, simply by repeated rejections. Further, even if the initial bad results are not rejected by the user, and subsequent errors are added thereto, the system provides the user the ability to skip back (i.e., to previous, previous-previous subgroup, etc.) where necessary to correct mistakes.

In light of the above, Table 1 summarizes five different ways in which a user could respond to feedback. The table is only illustrative, as the speaker may respond in many other ways.

TABLE 1

| Example | | |
|---|---|---|
| Response | Description | System/User Action |
| 123 | Lack of negative response by system | User continues with next utterance |
| | implies confirmation of previous results | |
| n123 | Indication that feedback of previous results | User follows prompt by repeating previous |
| | were incorrect via system prompt | utterance |
| n | Previous results incorrect | With no additional voice input, system |
| | | responds with feedback of previous-previous |
| | | results |
| 4n123 | User realizes they misspoke, indicating that | User follows with correctly spoken utterance |
| | results of initial utterance should be rejected | |
| 4n | User realizes they misspoke, indicating that | With no additional voice input, system |
| | results of initial utterance should be rejected | responds with feedback of previous-previous |
| | | results |

Referring to Table 1, the user can correct recognition errors based on feedback, and can correct user mistakes within the current utterance. In the first case and as previously discussed, within the same utterance as the “no” response the user preferably will immediately repeat the previous utterance. If the user only provides the “no” response, the system rejects the previous utterance, and repeats the feedback for the utterance prior to it (i.e., previous-previous utterance). This allows previously verified results to be rejected. In the second case, the user can immediately reject and correct a misspoken word within the same utterance, without needing to wait for feedback.

An attempt can be made to generate feedback whenever voice-recognition results become available. But if the previous feedback was ignored, as in instance (c) above, the previous results are also included with the current feedback. In fact, the feedback will contain all previous non-verified results as long as the user interrupts the prompts with the next set of digits.

While this may seem no better than if the user were to speak a long digits string as one utterance, the recognition results will be less error-prone because smaller digit-strings can be more accurately recognized than longer strings. Of course, if there were an error, the entire digits-string of the smaller subgroup, which is composed of all the non-verified/unconfirmed subgroups, would be rejected and would need to be repeated by the user. Further, the start of any utterance by the user interrupts the feedback. This utterance may contain words outside of the expected grammar, such as “huh” for example.

All previous subgroups of a long digit string may be implicitly verified, i.e., when the next subgroup is recognized by omission of a “no” response from the user. But after the last subgroup of a long digit sequence for example, there isn't another utterance. The inventors have identified this, and provide several alternatives to account for this last subgroup. In one embodiment, the system times out after some predetermined duration and passes on the accumulated results. Alternatively, the system may provide feedback (i.e., generate prompts) to require the user to explicitly confirm that the full digit-string is complete. Such may be accomplished by the user confirming that the last replayed subgroup of the complete digit sequence is correct by speaking some special word such as “Ok” or “correct”, for example. This present invention is not limited solely to these termination schemes, as other schemes within the skill of the art are also applicable.

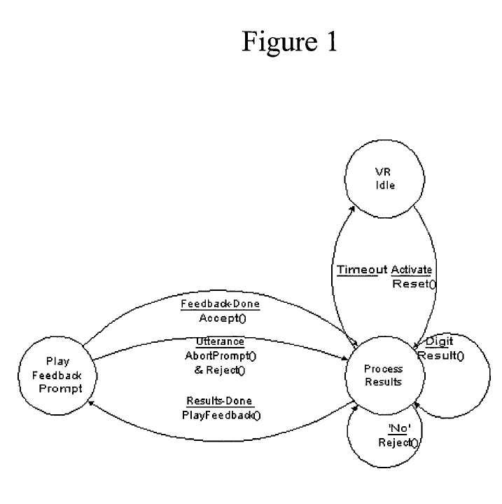

FIG. 1 is a state diagram that generally describes the method in accordance with the present invention, The state diagram includes states VR Idle, Process Results and Play Feedback Prompt and the following events/actions:

1. Activate/Reset( )

2. Digit/Result( )

3. “no”/Reject( )

4. Results-Done/PlayFeedback( )

5. Feedback-Done/Accept( )

6. Utterance/AbortPrompt( ) & Reject( )

7. Timeout/(no action, user implemented)

In the state diagram of FIG. 1, the recognition results are saved as a sequence of sub-digit-sequences rather than concatenating all results into a single sequence. This allows each sub-sequence to be subsequently rejected, which may be needed when “no” is mis-recognized, and recognition results are unintentionally confirmed. Accordingly, a mechanism to reject verified results has also been considered, and could be operatively accomplished as follows. While trying to determine a complete digit-sequence, intermediate results are stored as sub-sequences or subgroups. These subgroups may be subsequently discarded by the system. In other words, previously verified results can be rejected.

A state-machine is defined by states, events/stimuli, and actions. A state requires memory. In software, a state-machine is implemented as a subroutine. The subroutine is executed, completed, and then other subroutines are executed. Each time the subroutine executes, it needs to know the state it was in from the previous time it was executed, hence, it draws this information from a memory.

An event is something that happens outside of the state-machine, but which is a defined input to the state machine. The state-machine would typically be invoked whenever one of these events occurs, and that event drives the state machine. A timer-expiration could also be an event. This would be an internal event.

An action is also a subroutine. Simply, defined, an action is what the state-machine does. An appropriate action is based on the current event and also the state when the state-machine was invoked or executed.

State-machines are typically described using tables, where rows in the table could represent state, and columns could signify events. The table entry for each state and event is the action for that case. The table defines an action for every possible event in every possible state, which allows different actions for the same event in different states. This arrangement also allows events to be ignored, hence no action, in various states.

While each action could also define what the next state is, the inventors have developed a table that, for each state and event, indicates the next state. More often than not, the next state may be the same state.

Table 2 below describes the data-structures used by the processing functions in accordance with the invention.

TABLE 2

| Data Structure | Description |
|---|---|
| buff[BufSize] | Array to store recognition results |
| iBuf | Index into buf of next available location |
| grp[GrpSize] | Array of indices into buf |
| iGrp | Index into grp of next available location |

Table 2 describes data-structures, the information needed to effectively maintain the recognition results as a list/sequence of sub-sequences. The parameter buf[ ] is an array/list of data, and actually contains all recognition results as a single, concatenated sequence of digits. The parameter iBuf can either be described as the length of the data in buf[ ], or the index/offset that locates where the next sequence of results are added to buf[ ]. The parameter grp[ ] is an array of data indicating the location within buf[ ] that each sub-sequence or subgroup starts. The parameter iGrp can either be described as the number of sub-sequences, or the next location in grp[ ] to add data.

The state diagram of FIG. 1 generally indicates the processing steps in accordance with the present invention. Each of these processing steps, which correlate to the above-noted actions are described in terms of pseudo code.

1. Reset( ). The Reset( ) action defines the initial conditions of the data for an activated event, and can be described with the following code expression (1):

void
reset( ) {

iBuf = 0; (1)
iGrp = 0;
grp [iGrp] = 0; }

For convenience, two data conditions are represented by the following macros: Empty( ) and Boundary( ). Empty( ) is the state of the data after reset. The Boundary( ) condition is also true because the current value of iBuf is a value in grp[ ]. The Boundary( ) condition is needed to determine if the NO response received from the user was the first recognition result within an utterance, or if user had said “1n456”, for example. These macros can be described with the following code expression (2):

#define Empty( ) (iBuf == 0)
#define Boundary( ) (iBuf == grp[iGrp]) (2)

2. Result( ). The Result( ) action is invoked for every digit recognition result. It simply places its argument, e.g., the recognition result, into the buffer. Once this function is invoked, the Boundary( ) condition is no longer true, as well as the Empty( ) condition. Result( ) can be described with the following code expression (3):

result (char c)
{ buf [iBuf ++] = c; } (3)

3. Reject( ). The Reject( ) action is invoked whenever the “no” response from the user is recognized. Reject( ) resets iBuf to the previous boundary, but must consider if iBuf is already at a boundary, or if the buffer is empty. Reject( ) can be described with the following code expression (4):

void
reject (char c) {

if (!Empty( ) && Boundary( ))

iGrp--; (4)

iBuf = grp[iGrp]; }

4. Playfeedback( ). The action PlayFeedback( ) determines which portion of the results that have been processed, if any, in order to generate a prompt from. For the purposes of this specification, Prompt( ) indicates that, although it may be provided with a pointer/index into the results buffer, the result data is not terminated and needs to be. In this case, the results data is null-terminated, but the length could probably just as easily be determined from iBuf and the argument to Prompt( ). The following code expressions (5) and (6) are provided to describe the Prompt( ) and Play Feedback( ) actions:

void
prompt (char *s) {

buf[iBuf] = NULL;
printf (“%s\n”, s); } (5)

void
playFeedback (char c) {

if (Empty( ))

printf (“\tfeedback: %s\n”, “results cleared”);

else {

if (Boundary(\))

iGrp--;

printf (“ tfeedback: ”);
prompt (&buf[grp[iGrp]]); } } (6)

5. Accept( ). The Accept( ) action is invoked after all the recognition results have been processed and fed back to the user. It is invoked between the subgroup boundaries maintained in grp[ ] making it possible to provide feedback for just the last utterance. However, the Accept( ) action must consider the case where no new results have been added, when the user says either “n” or “12n”, for example. Accepto can be described with the following code expression (7):

void
accept (char c) {

if (!Boundary( )) (7)

grp[++ iGrp] = iBuf; }

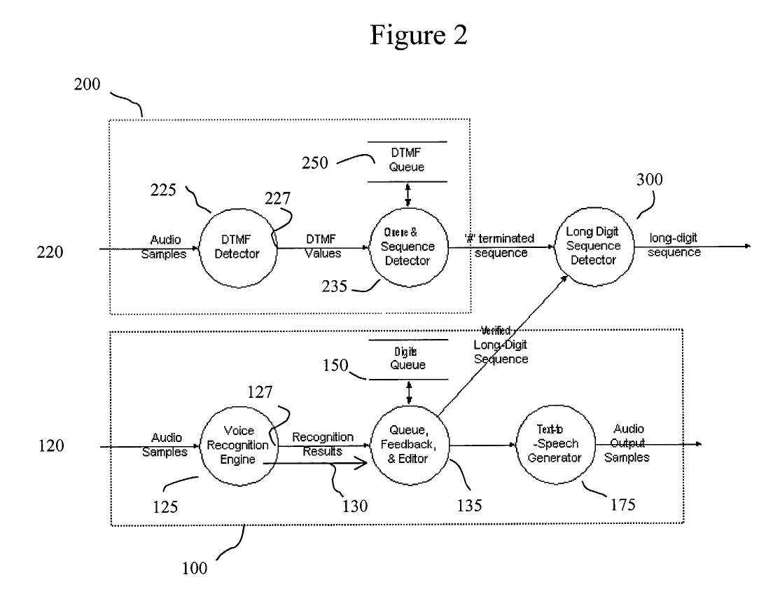

FIG. 2 is an illustrative block diagram showing comparable functionality between a DTMF system and the voice recognition system of the invention. Referring to FIG. 2, the voice recognition system 100 includes voice recognition engine 125 for processing input audio samples 120 that are received as speech data, a system controller 135 and a TTS generator 175. VR system 100 is shown in comparison to a typical DTMF section 200 for processing audio samples that are received as DTMF tones. DTMF section 200 is not part of this invention. System controller 135 is a queue, feedback and processing section (hereinafter QFE 135) that processes recognition results 127 and a start of utterance indication 130 received from VR engine 125 and provides feedback in accordance with the invention. Start of utterance indication 130 is the utterance event in the state diagram of FIG. 1, and allows the user to interrupt a prompt from QFE 135.

Each recognized sequence that is output from QFE 135 is received by a Long Digit Sequence Detector LDSD 300 that in turn outputs an accurate and complete long speech or digit sequence to downstream circuitry or components (not shown) connected to the voice recognition system 100. LDSD 300 receives a complete sequence either representing a complete credit card number from a DTMF queue and sequence detector 235 (QS 235) or from QFE 135, and passes that sequence to the aforementioned downstream circuitry. In the event a system contains both DTMF section 200 and VR system 100, QFE 135 and QS 235 do not generate results simultaneously.

Thus, there are two ways to input a long-digit sequence such as a credit-card number, either by using a touch-tone phone and DTMF detection, or by using speech and voice-recognition detection. As noted above, LDSD 300 is responsible for passing a long-digit sequence from VR system 100 on to the rest of the system or to another component connected thereto.

QFE 135 may be a digital signal processor as described above that receives recognition results from VR engine 125, and which accesses a digit queue 150 operatively connected thereto that temporarily store results. QFE 135 outputs a verified long digit sequence to LDSD 300, and sends feedback data to a Text-to-Speech Generator (TTS) 175 for suitable processing before the audio feedback is sent to a user of the system 100.

DTMF section 200 includes a DTMF detector 225 for detecting received DTMF tones, and the aforementioned QS 235 that accesses a DTMF queue 250 operatively connected thereto for temporarily storing DTMF values. DTMF section 200 outputs a verified long digit sequence to LDSD 300 when DTMF detector 235 detects a DTMF tone or value corresponding to the pound sign (#), indicating that the user has completed the entire sequence. DTMF section 200 is known in the art and is not part of the present invention; thus any further detail regarding DTMF section 200 is omitted.

Digit queue 150 is essentially a buffer that temporarily holds recognition results until all speech units or digits have been processed and/or verified. This may be embodied as an SDRAM, which is a specific implementation of a memory device. It is noted that the invention is not limited to the specific implementation of an SDRAM and can include any other known or future developed memory technology.

Within VR system 100, VR engine 125 has enough to do just determining which digits were spoken. The speaker may speak slowly, with long pauses between digits such that each digit is a single utterance. Thus, each digit could be outputted individually by VR engine 125. Alternatively, the speaker or user could say all 16 digits in a single utterance, increasing the likelihood of errors. Accordingly QFE 135 is responsible for collecting all the digit sequences from VR engine 125, and for passing a complete sequence to LDSD 300. Additionally, QFE 135 allows for corrections, as previously described above with respect to the processing steps outlined in FIG. 1.

Specifically, QFE 135 receives recognition results from VR engine 125. These results may be digit-sequences from one to many digits. QFE 135 concatenates the current recognition results with previous results stored in buffer 150, and plays back the current recognition result via TTS generator 175 (i.e., feeds back one digit-sequence or subgroup to the user). If the user rejects the result, QFE 135 discards the current recognition result, un-concatenates them, and waits for the next recognition results from VR engine 125. If no recognition results are received within some time out period, the complete, QFE 135 passes on the concatenated results as a complete digit sequence to LDSD 300, such as a credit card number, even though the credit card number was received by VR system 100, and specifically by QFE 135, as several shorter digit-sequences or subgroups.

Moreover, after listening to the feedback of a previously spoken utterance or subgroup from TTS generator 175, a user may return a negative utterance such as “no” to indicate that the previous subgroup was incorrectly recognized. QFE 135 thus removes the previous subgroup from the total number of subgroups or sequences stored in digit queue 150. In this arrangement, the user is expected to repeat the incorrect subgroup identified by system 100 and fed back via TTS generator 175. In this way, QFE 135 provides a means of using the imperfect recognition results from the VR engine 125 to provide reliable results to the LDSD 300.

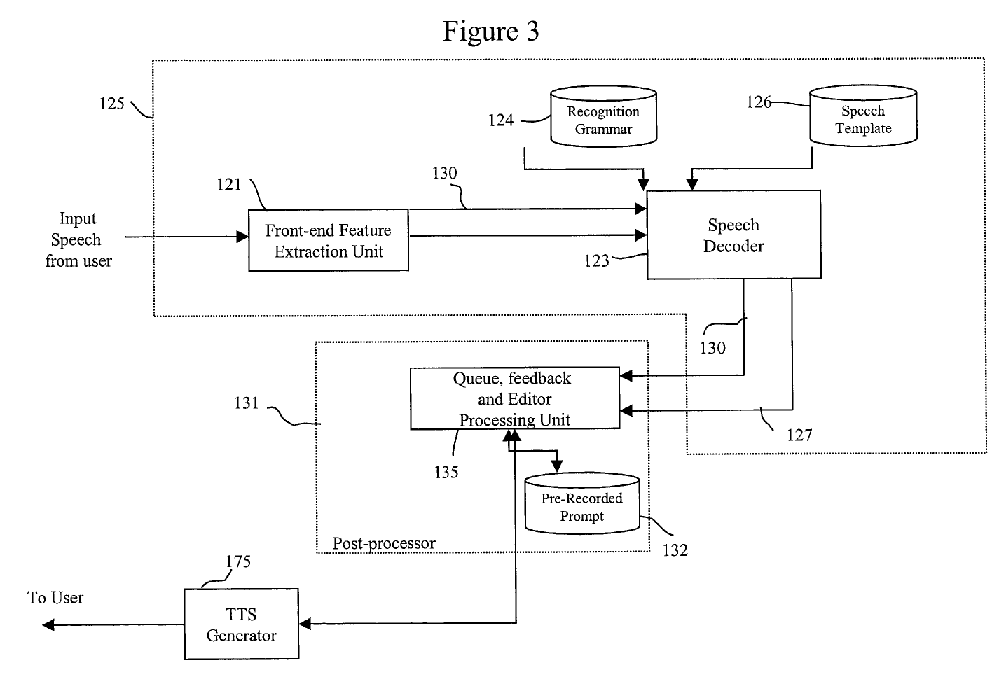

FIG. 3 is a block diagram illustrating a more detailed configuration of the voice recognition system 100, including voice recognition engine 125, system controller 135 and TTS generator 175. The VR system 100 and/or its components may be implemented through various technologies, for example, by the use of discrete components or through the use of large scale integrated circuitry, applications specific to integrated circuits (ASIC) and/or stored program general purpose or special purpose computers or microprocessors, including a single processor such as the digital signal processor (DSP) previously noted above, using any of a variety of computer-readable media. The present invention is not limited to the components pictorially represented in the exemplary FIG. 3, however; as other configurations within the skill of the art may be implemented to perform the above-described functions and/or processing steps of VR system 100.

In FIG. 3, VR engine 125 may be comprised of a front-end feature extraction unit 121, speech decoder 123, and recognition grammar memory 124 and speech template memory 126. Additionally, QFE 135, in addition to the buffer queue 150 of FIG. 2 (not shown), may be configured as part of a post-processor 131 that provides greater functionality than just what is described in FIG. 2 with reference to QFE 135.

Post-processor 131 contains all the capabilities of QFE 135 as described in FIG. 2, and provides additional capabilities based upon the type of rejections received from the user. Post-processor 131 contains additional rules or algorithms that can evaluate a user's “frustration factor”, for example (i.e., the amount of consistent/continuous rejections received by a user in response to a recognition result). Additionally, post-processor 131 may be configured to evaluate a particular type of rejection received from a user of the system in order to select an appropriate message, or prompt, to send to the user, which could be in the form of an instructional message such as “Please slow down” or “Please say fewer digits” for example.

Post-processor 131 may include a memory that could be internal or operatively connected thereto, such as a pre-recorded prompt memory 132, from which the QFE 135 may access particular prompts. Alternatively or in addition, post processor 131 (via QFE 135) may be operatively connected to and communicate with TTS generator 175. The output from the post-processor 131 (via TTS 175) is at least one of either a pre-recorded prompt, or the recognition result that has been converted from text to speech in TTS generator 175, which is fed back to the user.

The input speech is presented to front-end feature extraction unit 121 that extracts only the information in the input speech required for recognition. Feature vectors represent the input speech data, as is known in the art. The feature vectors and an utterance-begin indication 130 that is originated from the front-end feature extraction unit 121 are sent to speech decoder 123. The speech decoder 123 detects a pause between input subgroups, and is responsible for determining the recognition result based on inputs from recognition grammar memory 124 and speech template memory 126. Specifically, decoder 123 determines the presence of speech. At the beginning of speech, the speech decoder 123 is reset, and the current and all subsequent feature vectors are processed by the speech decoder using the recognition grammar memory 124 and speech template memory 126.

Recognition grammar memory 124 and speech template memory 126 may be embodied as SDRAMs, such as was described regarding the buffer queues in FIG. 2. The invention is not limited to this specific implementation of an SDRAM and can include any other known or future developed memory technology. Regardless of the technology selected, the memory may include a buffer space that may be a fixed or virtual set of memory locations that buffers or which otherwise temporarily stores speech, text and/or grammar data.

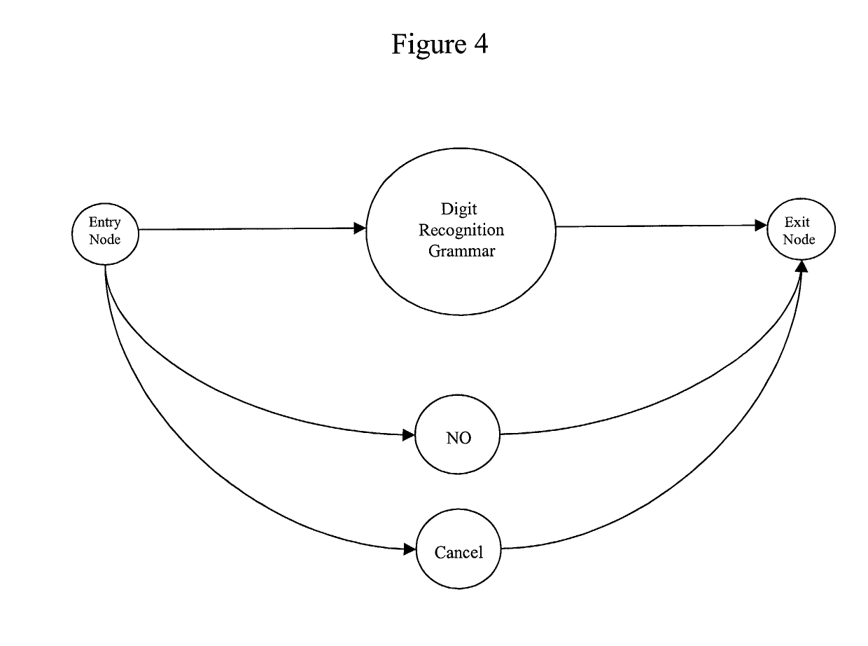

FIG. 4 illustrates the contents of an exemplary recognition grammar memory 124. The grammar memory 124 contains recognition grammar that includes digit recognition grammar. These may preferably be the spoken numbers 0-9, the spoken “zero” and several phrases that allow rejection of the input utterance by the user. However, individual letters and spoken words may also be stored within recognition grammar 124, based on memory limitations. Exemplary rejection phrases or negative utterances stored in recognition grammar memory 124 could be the spoken word “no” or “cancel” or other phrases that may be included therein.

Speech decoder 123 outputs a recognition result that contains at least one or more digits, letters and/or words specified in the grammar. Additionally within speech decoder 123, a confidence level may be determined for and assigned to the input recognition result. Determination of confidence levels may be effected using a suitable method such as is described in commonly-owned U.S. Pat. No. 5,566,272 to Brems et al., entitled “Automatic Speech Recognition (ASR) Processing Using Confidence Measures”; thus a detailed description is hereafter omitted. In an alternative embodiment, the confidence level processing functions could be performed in a dedicated processor that is separate but operatively connected to speech decoder 123.

The recognition result 127 and start of utterance indication 130 is then passed to QFE 135 within post-processor 131, which can take several actions based upon the outputs received from speech decoder 123. Such actions reflect the possible feedback results outlined above, and briefly reiterated here. For example, if the system 100 does not recognize the input subgroup, QFE 135 could access one of a plurality of pre-recorded messages stored in an internal memory (not shown) or pre-recorded prompt memory 132 of post-processor 131, in order to provide instruction(s), ask for clarification, or to provide other informative feedback to the user.

Additionally, QFE 135 could generate a prompt, via TTS generator 175, containing the recognized subgroup of digits and a “no” phrase that is included in the grammar. TTS generator 175 converts a text string to speech, as is well known in the art, by concatenating a sequence of speech or sound units that comprise the subgroup, as determined from the input text string. User affirmation of a correct subgroup preferably may be silence by the user for a period of time after receiving the playback of the result that is the correct interpretation of the input subgroup, and/or an utterance of the follow-on subgroup.

The above process is repeated for each input subgroup of speech units until a complete longer digit-sequence has been recognized in its entirety. This is determined when the “Timeout event” is met after the completion of recognizing the final subgroup of the complete digit sequence. As noted above, a rejection criteria is satisfied if the user speaks a negative utterance after receiving the result from TTS 175 via QFE 135. The rejection criteria is also met if a negative utterance is spoken by the user while inputting a particular subgroup of speech units that is later recognized at speech decoder 123. The negative utterance of course will be contained within the recognition result grammar that is sent to QFE 135.

In the case where the rejection criteria are met repeatedly (i.e., the output of post-processor 131 is a series of prompts asking for the previous subgroup, previous-previous subgroup, etc., or is asking what exactly the user intended to say), the post-processor 131 may send a message or prompt to the user asking the user to speak the subgroups in smaller groups of speech units. This in effect provides a built-in training mechanism for the user. Alternatively if the rejection criteria are met repeatedly, the post-processor 131 may generate and send a prompt to the user asking them to use a dial pad key that corresponds to each speech unit. Such a scenario envisions the user who has a strong dialect or accent, as in the Brooklyn native example, which could make speech recognition difficult.

Therefore, the system and method of the present invention provide greater accuracy in recognizing digit sequences by correctly interpreting the smaller subgroups of the sequence that are generally spoken by a user between natural pauses. Recognition results improve if the user speaks to a voice-recognition system as if it were human, providing pauses to process the subgroups of digits. The “breaking up” of long digit strings into subgroups allows the system, or the human user, the opportunity to provide immediate feedback and correction, so that any mistakes are corrected. Corrections can be made on a subgroup basis, with the corrected results being temporarily stored until the digit-sequence has been completed, rather than returning to the beginning of the long-sequence digit string.

The invention being thus described, it will be obvious that the same may be varied in many ways. Such variations are not to be regarded as departure from the spirit and scope of the invention, and all such modifications as would be obvious to one skilled in the art are intended to be included within the scope of the following claims.

What is claimed is:

1. A method of recognizing speech in systems that accept speech input, comprising:
(a) receiving at least a current subgroup of speech units that form part of a complete speech sequence that is to be input from a user;
(b) detecting a natural pause between input subgroups;
(c) recognizing the speech units of the subgroup to provide a recognition result; and
(d) immediately feeding back the recognition result for verification by the user,

2. The method of claim 1, wherein said user is only prompted to repeat said subgroup for re-recognition and re-verification if a rejection criteria is met.

3. The method of claim 1, further comprising:
(e) repeating steps (a) to (d) for remaining input subgroups until it is determined that the complete speech sequence has been recognized.

4. The method of claim 1, wherein step (d) is effected using pre-recorded prompts or via text-to-speech synthesis, (TTS) to feedback the recognition result.

5. The method of claim 2, wherein said rejection criteria is embodied as a negative utterance spoken by the user after receiving the fed back recognition result.

6. The method of claim 2, wherein said rejection criteria is embodied as a negative utterance spoken by the user concurrent with inputting the subgroup that is recognized in step (c).

7. The method of claim 2, wherein if said rejection criteria are met repeatedly, the user is prompted to speak the subgroups in smaller groups of speech units.

8. The method of claim 7, wherein said prompt to speak subgroups in smaller groups of speech units provides a built in training mechanism for the user.

9. The method of claim 2, wherein if said rejection criteria are met repeatedly, the user is prompted to use a dial pad to enter the speech units.

10. The method of claim 1, wherein said speech units are selected from any of spoken digits, spoken letters and spoken words.

11. The method of claim 1, wherein input of a next subgroup after receiving the fed back recognition result indicates a correct recognition of the currently input subgroup.

12. The method of claim 2, wherein said rejection criteria requires determining a level of confidence in said recognition result.

13. An automatic speech recognition system, comprising:
a receiver for receiving at least a current subgroup of speech units that form part of a complete speech sequence that is to be input by a user;
a detector for detecting a natural pause after receiving the subgroup;
a decoder for detecting a natural pause between input subgroups to output a recognition result representative of the current subgroup; and
a controller for evaluating the output recognition result and feeding back the recognition result to the user.

14. The system of claim 13, wherein said user is only prompted to repeat said subgroup for re-recognition and re-verification if a rejection criteria is met.

15. The system of claim 13, wherein the decoder compares the input subgroup with stored recognition grammar in order to determine the recognition result.

16. The system of claim 18, wherein the recognition grammar is stored in a remote memory accessible by the decoder.

17. The system of claim 14, wherein the recognition result includes at least one of a subgroup of speech units and a negative utterance representation that is included in the recognition result, and wherein the rejection criteria is met if the negative utterance is included therein.

18. The system of claim 14, wherein said rejection criteria is met if the user speaks a negative utterance after receiving the fed back recognition result.

19. The system of claim 14, wherein said rejection criteria is met if the user speaks a negative utterance while inputting the current subgroup, so that said recognition result includes the negative utterance.

20. The system of claim 14, wherein the system remains active to process subsequent subgroups until it is determined that the complete speech sequence has been recognized.

21. The system of claim 13, wherein said controller accesses pre-recorded prompts or a text-to-speech synthesis processor in order to effect feedback of the recognition result to the user.

22. The system of claim 14, wherein if said rejection criteria is met repeatedly, said controller prompts the user to speak the subgroups in smaller groups of speech units.

23. The system of claim 22, wherein said prompt to speak subgroups in smaller groups of speech units provides a built in training mechanism for the user.

24. The system of claim 14, wherein if said rejection criteria is met repeatedly, said prompt generator prompts the user to use a dial pad to enter digits corresponding to the speech units.

25. The system of claim 13, wherein said speech units are selected from any of spoken digits, spoken letter and spoken words.

26. The system of claim 13, wherein input of a next subgroup after receiving the fed back recognition result indicates a correct recognition of the currently input subgroup.

27. The system of claim 13, wherein said decoder determines a confidence level for said recognition result.
